(19) United States
(12) Patent Application Publication
(10) Pub. No.: US 2026/0178855 A1
(43) Pub. Date: Jun. 25, 2026

(54) METHODS AND SYSTEMS FOR MULTI-LANGUAGE AND MULTI-USER VOICE-TO-VOICE TRANSLATION IN REAL-TIME

(71) Applicant: Samsung Electronics Co., Ltd., Suwon-si (KR)

(72) Inventors: Sandeep Singh SPALL, Bangalore (IN); Choice CHOUDHARY, Bangalore (IN)

(21) Appl. No.: 19/537,118

(22) Filed: Feb. 11, 2026

Related U.S. Application Data
(63) Continuation of application No. PCT/KR2024/008226, filed on Jun. 14, 2024.

(30) Foreign Application Priority Data
Aug. 26, 2023 (IN) 202311057304

(51) Int. Cl. G06F 40/58; G06F 40/40; G10L 15/22

(52) U.S. Cl. CPC G06F 40/58; G06F 40/40; G10L 2015/223

(57) ABSTRACT

A multi-language voice-to-voice translation method and a system is disclosed using a uniquely designed conversation manager module. According to an embodiment, the conversation manager module converts each of the received one or more utterances into text data. The conversation manager module recognizes a language corresponding to each of the one or more utterances. Further, the conversation manager module segments, the converted text data, into one or more segments. A language processing model then translates the one or more segments into an output language. The conversation manager module fetches a tone style embedding similar to the received one or more utterances from a database. Audio output is generated in the output language along with the tone style embeddings. Thus, the generated output is the translated output in the output language having a style of a user who is uttering it.

### CROSS-REFERENCE TO RELATED APPLICATIONS

This application is a continuation of International Application No. PCT/KR2024/008226 designating the United States, filed on Jun. 14, 2024, in the Korean Intellectual Property Receiving Office and claiming priority to Indian Patent Application number 202311057304, filed on Aug. 26, 2023, in the Indian Patent Office, the disclosures of each of which are incorporated by reference herein in their entireties.

### BACKGROUND

### Field

The disclosure relates to a voice translational system and, for example, the disclosure relates to systems and methods for multi-language and multi-user voice-to-voice translation in real time.

### Description of Related Art

Recently, language translational tools have been widely embraced worldwide for fostering effective communication. A remarkable advancement in this field is multilingual voice-to-voice translation systems that allows individuals to communicate effortlessly by overcoming language barriers. This allows bridge communication gaps between people speaking different languages. The multilingual voice-to-voice translation system uses advanced natural language processing and machine learning algorithms to translate spoken or written words from one language to another, facilitating smooth interaction and mutual understanding among people from diverse linguistic backgrounds.

However, the existing multilingual voice-to-voice translation systems are limited to translating one language at a time.

FIG. 1 illustrates an example scenario, according to the state-of-the-art techniques. Consider that a Speaker 1 is uttering in the English language, a Speaker 2 is uttering in the French language, and a Listener 1 is uttering in the Korean language. According to the existing multilingual voice-to-voice translation systems, only one person can communicate at one time. Thus, making the other users wait for their turn to speak. Accordingly, the existing multilingual voice-to-voice translation systems are ineffective in a multi-user and multi-language scenario.

Furthermore, the output voice from the existing multilingual voice-to-voice translation systems does not capture the vocal characteristics of the speaker. Thereby providing a perception of a mechanical and/or artificial sound. As a consequence, the interaction becomes less empathetic and less likely to cater to specific context-based needs.

The existing multilingual voice-to-voice translation systems are also not accurate in translation, especially with complex or context-dependent phrases, leading to misunderstandings or unintended offenses. The existing multilingual voice-to-voice translation systems may struggle with complex idiomatic expressions or cultural nuances. For example, consider a case in the example scenario for FIG. 1, where the Speaker 1 is uttering in English, and in between he is also uttering in French. Thus, in such complex idiomatic expressions, the existing multilingual voice-to-voice translation systems fail to effectively segment the utterance of the user. Additionally, the existing multilingual voice-to-voice translation systems are less effective for translating uncommon languages or dialects, or slang.

The above information is presented as background information to aid in understanding of the disclosure. No assertion or determination has been made as to whether any of the above might be applicable as prior art with regard to the disclosure.

### SUMMARY

According to an example embodiment of the disclosure, a multi-language voice-to-voice translation method is disclosed. The method includes: receiving audio input including one or more utterances from one or more users in a multi-user environment; converting each of the received one or more utterances into a text data respective of the one or more utterances; recognizing a language corresponding to each of the one or more utterances based on the text data and acoustic features corresponding to each of the one or more utterances; segmenting the converted text data corresponding to the one or more utterances into one or more segments based at least on the recognized language corresponding to each of the one or more utterances and translating each segment of the one or more segments into an output language; and generating an audio output in the output language corresponding to the translated one or more segments.

According to an example embodiment of the disclosure, an apparatus for multi-language voice-to-voice translation is disclosed. The apparatus includes: at least one processor, comprising processing circuitry, individually and/or collectively, configured to cause the apparatus to: receive audio input including one or more utterances from one or more users in a multi-user environment; convert each of the received one or more utterances into a text data respective to the one or more utterances; recognize a language corresponding to each of the one or more utterances based on the text data and acoustic features corresponding to each of the one or more utterances; segment the converted text data corresponding to the one or more utterances into one or more segments based at least on the recognized language corresponding to each of the one or more utterances and translating each segment of the one or more segments into an output language; and generate an audio output in the output language corresponding to the translated one or more segments.

To further clarify advantages and features of the disclosure, a more detailed description of the disclosure will be rendered with reference to various example embodiments thereof, which are illustrated in the appended drawings. It will be appreciated that these drawings depict example embodiments of the disclosure and are therefore not to be considered limiting its scope. The disclosure will be described and explained with additional specificity and detail with reference to the accompanying drawings.

### BRIEF DESCRIPTION OF THE DRAWINGS

The above and other aspects, features, and advantages of certain embodiments of the present disclosure will be more apparent from the following detailed description, taken in conjunction with the accompanying drawings, wherein like characters represent like parts throughout the drawings, and in which:

FIG. 1 is a diagram illustrating an example scenario;

FIG. 2 is a block diagram illustrating an example configuration of a multi-language voice-to-voice (MLV2V) translation system, according to various embodiments;

FIG. 3 is a block diagram illustrating various example modules/engines of the MLV2V translation system of FIG. 2, according to various embodiments;

FIG. 4 is a diagram illustrating an example operation of the MLV2V translation system, according to various embodiments;

FIG. 5 is a flowchart illustrating an example MLV2V method, according to various embodiments;

FIG. 6 is a diagram illustrating an example network structure for multiple user detection, according to various embodiments;

FIG. 7 is a flowchart illustrating an example method for obtaining a speaker embeddings (tone) associated with each of the audio inputs, according to various embodiments; and

FIG. 8 is a flowchart illustrating an example process of utterance segmentation, according to various embodiments.

Further, skilled artisans will appreciate that elements in the drawings are illustrated for simplicity and may not have necessarily been drawn to scale. For example, the flowcharts illustrate the method in terms of steps/operations to help to improve understanding of aspects of the disclosure. Furthermore, in terms of the construction of the device, one or more components of the device may have been represented in the drawings by conventional symbols, and the drawings may show details that are pertinent to understanding the various example embodiments of the disclosure so as not to obscure the drawings with details that will be readily apparent to those of ordinary skill in the art having the benefit of the description herein.

### DETAILED DESCRIPTION

It should be understood at the outset that although various example implementations of the disclosure are illustrated below, the disclosure may be implemented using any number of techniques, whether currently known or in existence. The disclosure should in no way be limited to the illustrative implementations, drawings, and techniques illustrated below, including the example design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” may be defined as meaning “no embodiment, or one embodiment, or more than one embodiment, or all embodiments.”

The terminology and structure employed herein is for describing, teaching, and illuminating various example embodiments and their specific features and elements and does not limit, restrict, or reduce the spirit and scope of the claims or their equivalents.

For example, any terms used herein such as but not limited to “includes,” “comprises,” “has,” “consists,” and grammatical variants thereof do NOT specify an exact limitation or restriction and certainly do not exclude the possible addition of one or more features or elements, unless otherwise stated, and furthermore should not be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language such as “there NEEDS to be one or more.” or “one or more element is REQUIRED.”

Unless otherwise defined, all terms, and especially any technical and/or scientific terms, used herein may be taken to have the same meaning as commonly understood by one having ordinary skill in the art.

Embodiments of the disclosure will be described below in greater detail with reference to the accompanying drawings.

According to an example embodiment, the disclosure discloses a method and a system for a multi-language voice-to-voice translation system in a multi-user environment using a uniquely designed conversation manager module. According to an embodiment, the conversation manager module converts each of the received one or more utterances into text data. The conversation manager module recognizes a language corresponding to each of the one or more utterances. Further, the conversation manager module segments, the converted text data, into one or more segments. A language processing model may then translate the one or more segments into an output language. The conversation manager module fetches a tone style embedding similar to the received one or more utterances from a database. An audio output is generated in the output language along with the tone style embeddings. Thus, the generated audio output is the translated output in the output language having a style the user who is uttering the said audio.

A detailed methodology is explained in the following disclosure.

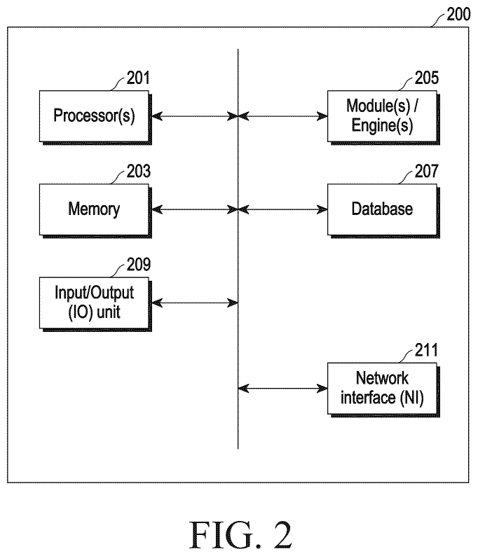

FIG. 2 is a block diagram illustrating an example configuration of a multi-language voice-to-voice (MLV2V) translation system, according to various embodiments.

Referring to FIG. 2, the ML V2V translation system 200 may include a processor(s) (e.g., including processing circuitry) 201, a memory 203, a modules/engines (e.g., including various circuitry and/or executable program instructions) 205, a database 207, an input/output (I/O) unit (e.g., including various circuitry) 109, and a network interface (NI) (e.g., including various circuitry) 211 coupled with each other.

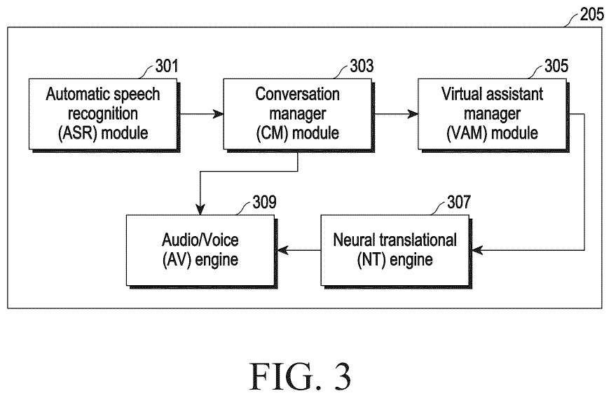

FIG. 3 is a block diagram illustrating an example configuration of various example modules/engines of the MLV2V translation system of FIG. 2, according to various embodiments. For example, the module(s)/engine(s) 205 as shown in FIG. 3 may include an automatic speech recognition (ASR) module 301, a conversation manager (CM) module 303, a virtual assistant manager (VAM) module 305, a neural translational (NT) engine 307, and an audio/video (AV) engine 309, each of which may include various circuitry and/or executable program instructions and may operate in collaboration with each other.

Referring back to FIG. 2, as an example, the MLV2V translation system 200 may correspond, for example, and without limitation, to various devices such as a personal computer (PC), a tablet, a personal digital assistant (PDA), a mobile device, a palmtop computer, a laptop computer, a desktop computer, a voice assistance device, a communications device, a computing device, or any other machine capable of executing a set of instructions.

As an example, the processor 201 may include various processing circuitry, including, for example, a single processing unit or a number of units, all of which could include multiple computing units. The processor 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201 may be configured to fetch and execute computer-readable instructions and data stored in the memory 203. Further, the function of the modules may alternatively be performed using processor 201. However, for the ease of understanding explanation is made through various modules of FIG. 3. Thus, the processor 201 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 203 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. According to an embodiment of the disclosure, the memory 203 may stores tone style of a corresponding user, speaker embeddings, acoustic features of an audio input and the like.

In an example, the module(s)/engine(s) 205 may include a program, a subroutine, a portion of a program, a software component, or a hardware component capable of performing a stated task or function. As used herein, the module(s)/engine(s) 205 may be implemented on a hardware component such as a server independently of other modules, or a module can exist with other modules on the same server, or within the same program. The module(s)/engine(s) 205 may be implemented on a hardware component such as processor one or more microprocessors, microcomputers, microcontrollers, digital signal processors, central processing units, state machines, logic circuitries, and/or any devices that manipulate signals based on operational instructions. The module(s)/engine(s) 205 when executed by the processor(s) 201 may be configured to perform any of the described functionalities.

As a further example, the database 207 may be implemented with integrated hardware and software. The hardware may include a hardware disk controller with programmable search capabilities or a software system running on general-purpose hardware. The examples of the database 207 are, but are not limited to, in-memory databases, cloud databases, distributed databases, embedded databases, and the like. The database 207, amongst other things, serves as a repository for storing data processed, received, and generated by one or more of the processors, and the modules/engines/units.

In an embodiment, the module(s)/engine(s) 205 may be implemented using one or more AI modules that may include a plurality of neural network layers. Examples of neural networks include but are not limited to, convolutional neural network (CNN), deep neural network (DNN), recurrent neural network (RNN), restricted boltzmann machine (RBM). The ‘learning’ may be referred to in the disclosure as a method for training a predetermined (e.g., specified) target device (for example, a robot) using a plurality of learning data to cause, allow, or control the target device to make a determination or prediction. Examples of learning techniques include but are not limited to, supervised learning, unsupervised learning, semi-supervised learning, or reinforcement learning. At least one of a plurality of CNN, DNN, RNN, RMB models and the like may be implemented to thereby achieve execution of the mechanism through an AI model. A function associated with an AI module may be performed through the non-volatile memory, the volatile memory, and the processor. The processor may include one or a plurality of processors. One or a plurality of processors may include a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors may control the processing of the input data in accordance with a specified operating rule or artificial intelligence (AI) model stored in the non-volatile memory and the volatile memory. The specified operating rule or artificial intelligence model is provided through training or learning.

As an example, an input/output (IO) unit 209 may include various circuitry and receive and output audio data of multiple users. In a non-limiting example, the IO unit 209 may include a microphone, and a speaker to receive and output the audio data respectively. As a further example, the NI 211 may establish a network connection with a network like a home network, a public network, or a private network and the like.

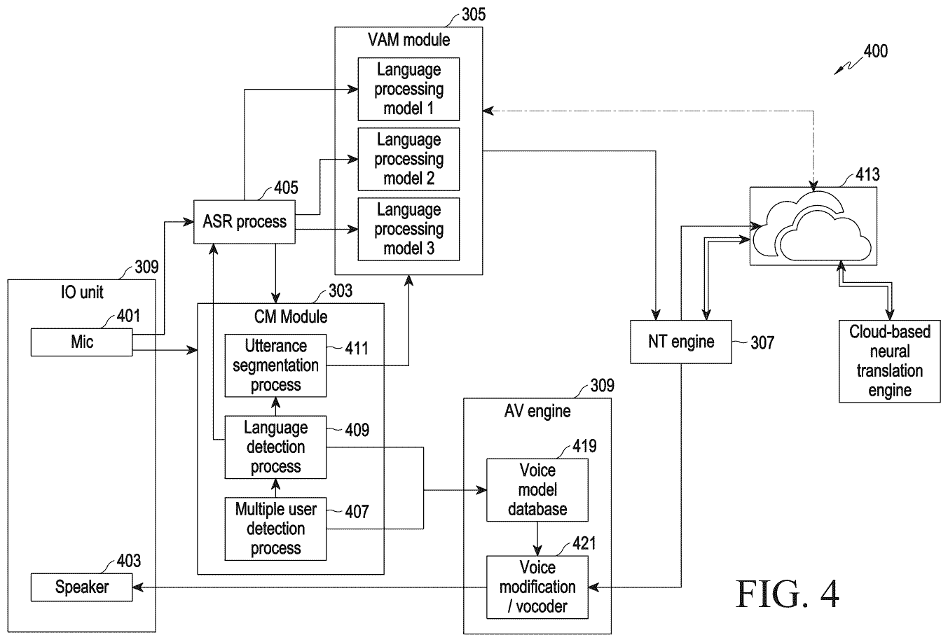

The components of FIGS. 2 and 3 will be described in greater detail below with reference to FIGS. 4 to 8.

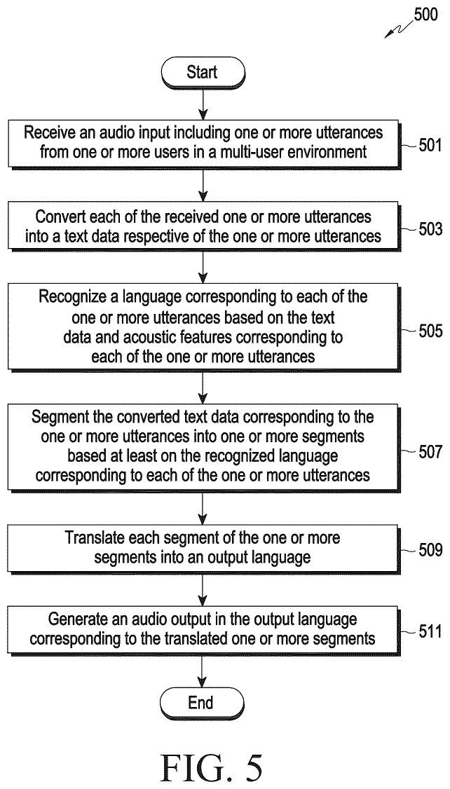

FIG. 4 is a block diagram illustrating an example operational flow of the MLV2V translation system, according to various embodiments. FIG. 5 is a flowchart illustrating an example MLV2V method, according to various embodiments. The method 500 will be explained through the operational flow 400 and various components illustrated in FIGS. 2 and 3 for ease of understanding and sake of brevity.

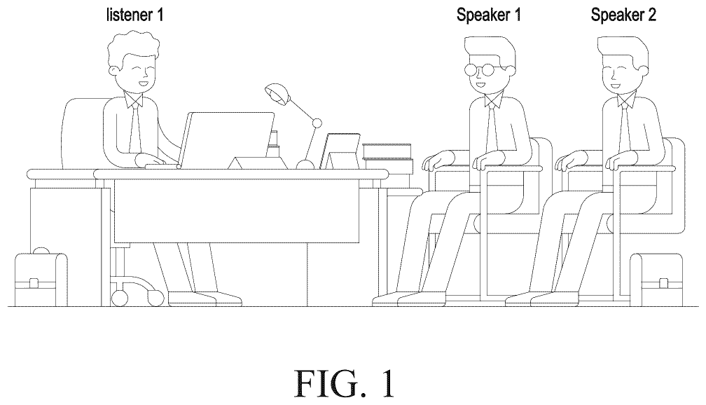

Considering an example, where the MLV2V translation system 200 may be implemented in the multi-user environment where more than one user is uttering and doing conversations with each other for instance, in the environment illustrated in FIG. 1. Further, consider that each of the users speaks and understands only one kind of language. For example, the Speaker 1 may speak only the English language and understands the English and the French language. Further, the Speaker 2 may speak only English and understands the English and the French language. Furthermore, the Listener 1 may only understand Korean.

Referring back to FIGS. 3, 4, and 5, according to an example embodiment, the microphone (mic) 401 corresponding to the IO unit 209 may receive audio input from one or more users. The audio input may include one or more utterances that are received from one or more users. Further, the audio input may be of the same language or a different language. In the case of the above-mentioned example scenario, the audio input may be received from the Speaker 1, the Speaker 2, and the Listener 1, who speaks and understands different languages. The receiving operation by the IO unit 209 may correspond to operation 501 of FIG. 5. At operation 503 an automatic speech recognition (ASR) module 301 may convert each of the received one or more utterances into text data respective to the one or more utterances. The ASR module 301 may transcribe the input audio into the text data using any suitable conversion technique such as, but not limited to, acoustic modeling, language modeling, Hidden Markov models (HMMs), connectionist temporal classification (CTC), and so forth. The process of converting the audio input to the text data is referred to as ASR process 405 in FIG. 4.

The conversation manager (CM) module 303 may also receive the audio input from the mic 401. The CM module 303 may be configured to differentiate each user from the one or more users in the multi-user environment based on a tone of the respective user. The CM module 303 may be configured to detect the spoken language and break the text data into segments so that a problem of wrong and/or no punctuation in the audio input can be overcome.

According to an example embodiment, the CM module 303 may extract one or more acoustic features corresponding to each of the one or more utterances based on the received audio input from the one or more users. In a non-limiting example, the one or more acoustic features may include, but not limited to, a waveform analysis, linear predictive cepstral coefficients (LPCC), Mel frequency cepstrum coefficient (MFCC), gamma tone frequency cepstral coefficients (GFCC), log-mel-spectrogram, grapheme, a phoneme, a tone, word pronunciation, vowel sounds, consonant sounds, the length and emphasis of the individual sounds, and the like. In a further non-limiting example, the LPCC features include 13 LPCC features, 13 Delta LPCC features, and 13 Delta LPCC features. Further, in another non-limiting example, the MFCC features include 12 MFCC Cepstral Coefficients, 12 Delta MFCC Cepstral Coefficients, 12 Double Delta MFCC Cepstral Coefficients, 1 Energy Coefficient, 1 Delta Energy Coefficient, 1 Double Delta Energy Coefficient. In yet another non-limiting example, the GFCC includes 12 GFCC Coefficients, 12 Delta GFCC Coefficients, 12 Double GFCC Cepstral Coefficients.

According to an example embodiment, for a multiple user detection process 407, the CM module 303 may differentiate each user from the one or more users in the multi-user environment based at least on the extracted one or more acoustic features.

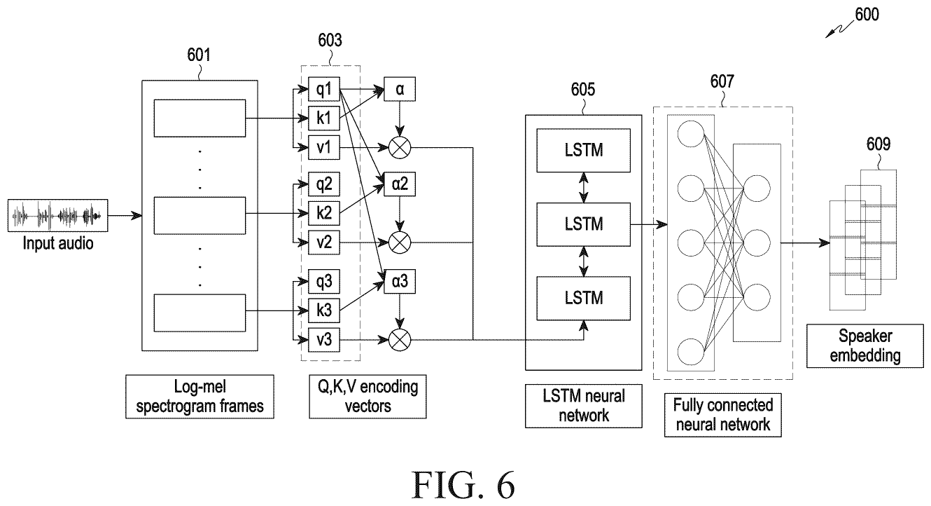

FIG. 6 is a diagram illustrating an example network structure for multiple user detection, according to various embodiments.

Referring to FIG. 6, the network structure 600 may be implemented in the CM module 303. The CM module 303 may detect a tone from the mel-spectrogram (e.g., acoustic features) for differentiating the users. In a non-limiting example, the network structure 600 may be a uniquely designed speech tone extractor using DNN model.

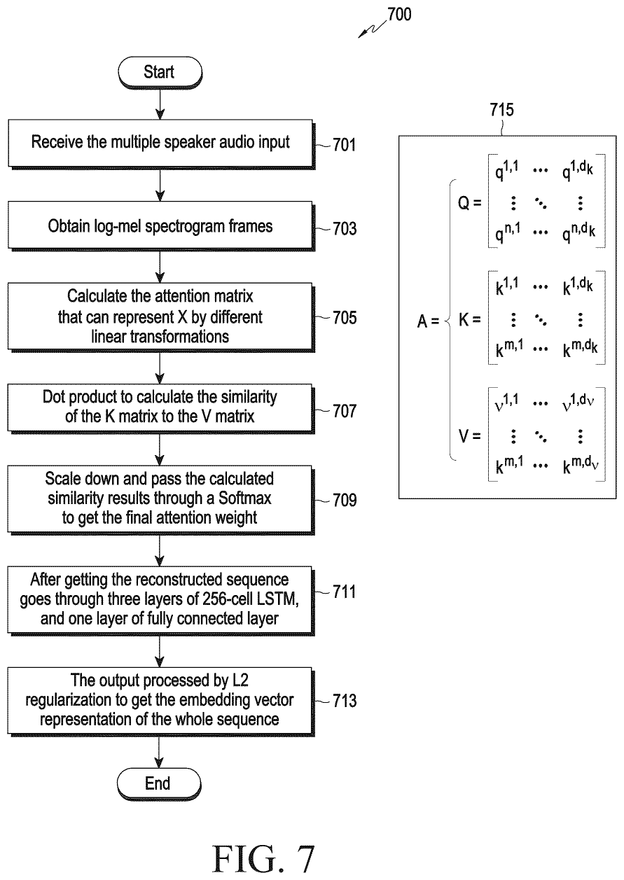

FIG. 7 is a flowchart illustrating an example method for obtaining a speaker embeddings (tone) associated with each of the audio inputs, according to various embodiments. Method 700 will be described in detail below with reference to FIG. 6.

According to an example embodiment, at operation 701, the CM module 303 may receive the audio input from multiple speakers. As explained above, the acoustic feature that includes the mel-spectrogram may be extracted from the audio inputs. From the mel-spectorgram, at operation 703, the CM module 303 may obtain a sequence of the log-mel spectrogram frames 601. Thereafter, from the sequence of log-mel spectrogram frames 601, at operation 705, the CM module 303 may calculate an attention matrix (A) 715 that may represent X by different linear transformations. Linear transformations are functions from one vector space to another vector that respects the linear structure of each vector space. According to the example embodiment, the attention matrix (A) may be calculated by different linear transformations. The attention matrix (A) may include Q, K, and V encoding vectors 603 which further process, and an output of the processing of the Q, K, and V encoding vectors may be sent to an LSTM neural network. According to an example embodiment, the Q, K, and V may be the vectors that are used to get better encoding for both source and target words. Q may indicate vector (linear layer output) related to an encoded output. As an example, the encoded output can be the output of an encoder layer or decoder layer. Further, K may indicate vector (linear layer output) related to utilization of input to output. Furthermore, V may indicate learned vector (linear layer output) as a result of calculations, related with input. Further, a may indicate a final result based on obtained weight coefficients that are multiplied with the attention matrix V and then summed up. The final result may correspond to alpha (α).

The processing of the Q, K, and V encoding vectors may include performing a dot product to calculate a similarity of the K matrix to the V matrix at operation 707. At operation 709, the CM module 303 may scale down and pass the calculated similarity results through a softmax layer (not shown) to get a final attention weight. The final attention weight may correspond to a. At operation 711, the sequence of log-mel spectrogram frames 601 may be reconstructed and passed to a long short-term memory (LSTM) neural network (NN) 605 and a one layer of fully connected convolution layer 607. In a non-limiting example, the LSTM NN 605 with three layers of 256-cell may be used. The output of operation 711 may be then processed by L2 regularization (not shown) to get an embedding vector representation of the whole sequence referred to as the speaker embeddings 609 at operation 713.

Thus, the LSTM NN 605 may focus more on voice feature of a target speaker and extracts the target features accurately. The LSTM NN 605 may build an optimal softmax loss to optimize the model. The LSTM NN 605 may cluster the voices of the same speaker and sparse the voices of different speakers. Accordingly, the multiple user detection process 407 may generate a vector representing the speaker's tone (e.g., speaker embeddings) and distinguish multiple speaker's voice features based on the speaker embeddings. A mathematical representation of the final reconstructed sequences, expression of similarity between encoding vectors, and an optimal softmax loss are given in detail below.

For the multiple user detection process 407 assumes there are three sequences A, B, and C as the audio input, then the final reconstructed sequences are given by equation 1:

$${A}^{′} = A * {W}_{a , a} + B * {W}_{a , b} + C * {W}_{a , c} \qquad [ equation 1 ]$$

Suppose eⱼᵢ denotes the ith utterance of the jth speaker, and Cₖ is denoted as the center of the kth speaker embedding, then S_{ji,k} can be expressed as the similarity between eⱼᵢ and Cₖ, is given by equation 2

$${S}_{ji , k} = w \cdot cos ( {e}_{ji} , {c}_{k} ) + b \qquad [ equation 2 ]$$

Optimal softmax loss, targeted to weight the samples of the target speakers, is given by equation 3:

$$L ( {e}_{ji} ) = {W}_{c} [ - {S}_{ji , j} + log {\sum }_{k = 1}^{N} exp ( {S}_{ji , k} ) ] \qquad [ equation 3 ]$$

Referring back to FIG. 5, at operation 505, the CM module 303 recognizes a language corresponding to each of the one or more utterances based on the text data and the acoustic features corresponding to each of the one or more utterances. The text data may be received by the ASR module 301. Further, the acoustic features such as mel spectrogram, MFCC, BFCC and speech feature extraction techniques such as perceptual linear prediction (PLP), and a revised perceptual linear prediction (RPLP) are used to recognize the language. The acoustic features are passed on to a convolution NN (CNN) for recognizing the language corresponding to each of the one or more utterances. In a non-limiting example, a 2D ConvNet model may be used. Operation 505 may, for example, correspond to a language detection process 409 of FIG. 4.

At operation 507, based at least on the recognized language corresponding to each of the one or more utterances, the CM module 303 may segment the converted text data corresponding to the one or more utterances into one or more segments. The process of segmenting the converted text data corresponding to the one or more utterances into one or more segments is depicted as an utterance segmentation process 411 of FIG. 4 and will be explained in greater detail below.

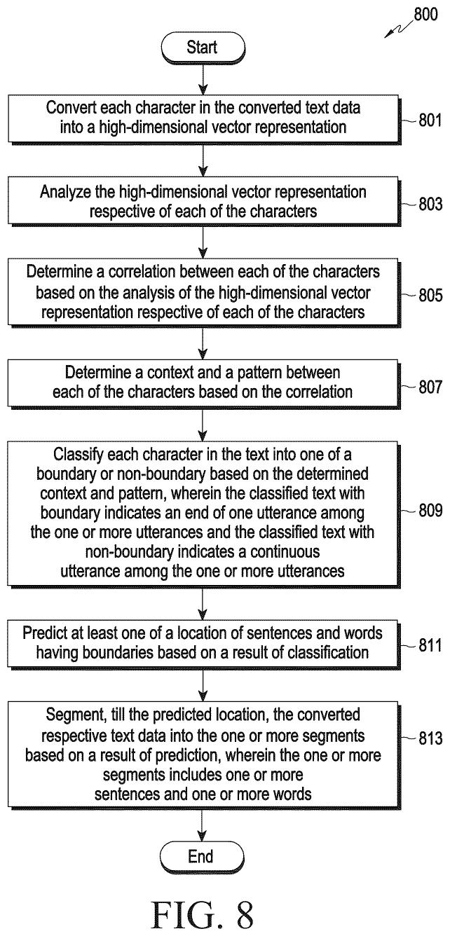

FIG. 8 is a flowchart illustrating an example process of the utterance segmentation, according to various embodiment. The utterance segmentation process 411 may address the problem of sentence segmentation with wrong and/or no punctuation. Accordingly, at operation 801, the CM module 303 may convert each character in the text data into a high-dimensional vector representation. The text data may be the data received from the ASR module 301. Further, text data can be in any language, and can contain complex grammar and punctuation. The conversion of the text data into the high-dimensional vector representation may be performed by an embedding layer of the NN that is implemented in the CM module 303. These embedding layers may capture information about a context and meaning of each character and allow the NN to understand the relationships between characters in the text. As a non-limiting example, global vectors (GloVe) algorithm may be used for obtaining the high-dimensional vector representation for words. The high-dimensional vector representation for words may be achieved by mapping words into a meaningful space where the distance between words is related to semantic similarity.

At operation 803, the CM module 303 may analyze the high-dimensional vector representation respective of each of the characters. In a non-limiting example, the analyses of the high-dimensional vector representation may bee performed by a BiLSTM network. The BiLSTM network may process the high-dimensional vector representation respective of each of the characters in both forward and backward directions and uses its memory cells to capture long-term dependencies between characters in the text, which allows the BiLSTM network to understand the context of each character based on the characters that came before and after it.

Accordingly, at operation 805, the CM module 303 may determine a correlation between each of the characters based on the analysis of the high-dimensional vector representation respective of each of the characters. At operation 807, the CM module 303 may determine a context and a pattern between each of the characters based on the correlation. At operation 809, the CM module 303 may classify each character in the text into one of a boundary or non-boundary based on the determined context and pattern. The classified text with boundary may indicate an end of one utterance among the one or more utterances and the classified text with non-boundary indicates a continuous utterance among the one or more utterances. For example, consider that the speaker 1 is continuously speaking a long paragraph. Along with speaking, the Speaker 2 needs to listen to what the Speaker 1 is saying. However, the Speaker 2 can't wait until the Speaker 1 finishes. Hence the segmentation of the text and breaking them into sentences may be performed so that the CM module 303 can do parallel processing along with the VAM module 305. Further, the classification of the boundary of the text may be performed so as to process the text data quickly. At operation 811, the CM module 303 may predict at least one of a location of sentences and words having boundaries based on a result of classification. In a non-limiting example, a conditional random field (CRF) model may be used to predict the optimal sequence of sentence or word boundaries by modeling the dependencies between adjacent characters. At operation 813, the CM module 303 may segment the converted respective text data into the one or more segments till the predicted location based on a result of prediction. The one or more segments may include one or more sentences and one or more words. Moreover, the CM module 303 may transmit the one or more segments to the VAM module 305 for processing the segments parallelly to the audio input.

The VAM module 305 may include a plurality of language processing models. For example, in FIG. 4, three language processing model, e.g., a language processing model 1, a language model 2, and a language processing model 3 is shown. However, the VAM module 305 may include any number of language processing models. Referring back to FIG. 5, at operation 509, the VAM module 305, translates each segment of the one or more segments into an output language. As an example, the output language may be selected based on user input from the one or more users in the multi-user environment or a pre-set language or a pre-defined selection criteria. For example, in FIG. 3, the Listener 1 may select the output language as Korean, and the speaker 1 and the Speaker 2 may select an output language as English.

Accordingly, operation 509, may includes selecting, by the VAM module 305, a language processing model from a plurality of language processing models for each segment of the one or more segments based at least on the recognized language corresponding to each of the one or more utterances in the respective segment. For example, if the recognized language in the segment is English then the language processing model that is capable to translate the English segment into Korean for Listener 1 is selected. Accordingly, the VAM module 305 may translate each segment into the output language using the corresponding selected language processing model. For example, the VAM module 305 may use the corresponding selected language processing model along with a cloud-based engine 413 for translating the segments into the user language. The cloud-based engine 413 may include a cloud-based neural translation engine 417. The cloud-based neural translation engine 417 may be a text translation engine to convert text from one language to another language. Accordingly, the corresponding selected language processing model may fetch the translated output language for the corresponding segments so as to output a translated segment corresponding to the output language for each segment. The translated corresponding segments e.g., an output of the VAM module 305 may be fed to the NT engine 307 for obtaining an improved translation. The output of the NT engine 307 may be then fed to the AV engine 309 for incorporating the tone styles for audio output.

According to an embodiment, the speaker embeddings that are generated during the multiple user detection process 407 may be further stored in a voice model database 419 of the AV engine 309. The voice model database 419 may include tone style embedding of the user that are jointly, trained within the CM module 303.

Referring back to FIG. 5, at operation 511, the AV engine 309 may generate the audio output in the output language based on the said integration of the fetched tone style embeddings in each of the translated segments. For the generation of the audio output, the AV engine 309 may fetch, from the voice model database 419, a tone style embedding similar to the extracted one or more acoustic features corresponding to each of the one or more utterances respective of each user from the one or more user. The AV engine 309 may integrate the fetched tone style embeddings in each of the translated segments which are received as the output of the NT engine 307. The output hence obtained may be then fed to a voice modification/vocoder 421 for correcting the output. According to an example, the voice modification/vocoder may convert speech 421 into user's language using the voice model (e.g., the fetched tone style embeddings) of the speaker voice. Accordingly, at operation 511 of FIG. 5, the AV engine 309 may generate the audio output in the output language based on the said integration of the fetched tone style embeddings in each of the translated segments. Accordingly, the audio output may be transmitted through the speaker 403 so that other users in the multi-user environment can listen. Accordingly, the audio output may be generated in the speaker's vocal.

In an example embodiment, consider that more than one user for example, user A, user B, and user C are in conversation with each other. Further consider that a user A is wearing an earbud and users B and C are speaking with each other while the earbud of user A is translating. According to a conventional art the spoken words of the users B and C hinder the translation process for the person A. However, the disclosed system considers this audio as noise as the disclosed system has a feature of selective audio cancellation. As the disclosed methodology uses audio attributes of the particular user for recognizing the specific user voice. This enables discarding the audio as noise. Accordingly, the speaking of the users B and C will be discarded by user A ear buds.

The disclosed techniques thus provide a real-time method for multi-language voice-to-voice translation in a real-time manner in the multi-user environment. The audio output hence generated is having similar vocal and tone style of the speaker. Furthermore, in case of multiple users speaking, then speakers are not required to wait as the translation process is performed simultaneously due to the segmentation process. The disclosed techniques handle multiple languages at the same time while seamlessly performing translation. Due to the segmentation process, slang words or phrases in the utterance can be translated easily.

While specific language has been used to describe the disclosure, any limitations arising on account of the same are not intended. As would be apparent to a person in the art, various working modifications may be made to the method in order to implement the disclosed concept as taught herein.

The drawings and the forgoing description describe various example embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims.

What is claimed is:

1. A method for multi-language voice-to-voice translation, comprising:
receiving an audio input including one or more utterances from one or more users in a multi-user environment;
converting each of the one or more utterances into a text data respective of the one or more utterances;
recognizing a language corresponding to each of the one or more utterances based on the text data and acoustic features corresponding to each of the one or more utterances;
segmenting the text data corresponding to the one or more utterances into one or more segments based at least on the language corresponding to each of the one or more utterances;
translating each of the one or more segments into an output language; and
generating an audio output in the output language corresponding to the translated one or more segments.

2. The method of claim 1, further comprising:
extracting the one or more acoustic features corresponding to each of the one or more utterances based on the received audio input from one or more users,
wherein the one or more acoustic features comprises at least one of a waveform analysis, linear predictive cepstral coefficients (LPCC), mel frequency cepstrum coefficient (MFCC) and gammatone frequency cepstral coefficients (GFCC), mel-spectrogram, grapheme, a phoneme, and a tone.

3. The method of claim 2, further comprising:
differentiating each user from the one or more users in the multi-user environment based on the extracted one or more acoustic features.

4. The method of claim 1, wherein the segmenting the respective text data into one or more segments comprises:
converting each of characters in the text data into a high-dimensional vector representation;
analyzing the high-dimensional vector representation respective of each of the characters;
determining a correlation between each of the characters based on the analysis of the high-dimensional vector representation respective of each of the characters;
determining a context and a pattern between each of the characters based on the correlation;
classifying each of the characters in the text into one of a boundary or non-boundary based on the determined context and pattern, wherein the classified text with boundary indicates an end of one utterance among the one or more utterances and the classified text with non-boundary indicates a continuous utterance among the one or more utterances;
predicting at least one of a location of sentences and words having boundaries based on a result of the classification; and
segmenting, until the predicted location, the converted respective text data into the one or more segments based on a result of the prediction, wherein the one or more segments includes one or more sentences and one or more words.

5. The method of claim 1, wherein the translating each of the one or more segments into the output language comprises:
selecting a language processing model from a plurality of language processing models for each of the one or more segments based at least on the recognized language corresponding to each of the one or more utterances in the respective segment; and
translating each of the one or more segments into the output language using the corresponding selected language processing model, wherein each of the one or more segments is translated in parallel with each other.

6. The method of claim 2, wherein generating the audio output comprises:
fetching, from a database, a tone style embedding similar to the extracted one or more acoustic features corresponding to each of the one or more utterances respective of each user from the one or more user;
integrating the fetched tone style embeddings in each of the translated one or more segments; and
generating the audio output in the output language based on the integration of the fetched tone style embeddings in each of the translated one or more segments.

7. The method of claim 1, wherein the output language is selected based on at least one of:
an input from the one or more users in the multi-user environment; and
a specified selection criteria based on the recognized language using the audio input or a specified language.

8. An apparatus for multi-language voice-to-voice translation, comprising:
memory storing instructions; and
at least one processor, comprising processing circuitry, communicatively coupled to the memory,
wherein the instructions, when executed by the at least one processor individually and/or collectively, cause the apparatus to:
receive an audio input including one or more utterances from one or more users in a multi-user environment;
convert each of the one or more utterances into a text data respective of the one or more utterances;
recognize a language corresponding to each of the one or more utterances based on the text data and acoustic features corresponding to each of the one or more utterances;
segment the text data corresponding to the one or more utterances into one or more segments based at least on the language corresponding to each of the one or more utterances;
translate each of the one or more segments into an output language; and
generate an audio output in the output language corresponding to the translated one or more segments.

9. The apparatus of claim 8, wherein for generating the audio output, a wherein the instructions, when executed by the at least one processor individually and/or collectively, cause the apparatus to:
extract the one or more acoustic features corresponding to each of the one or more utterances based on the received audio input from one or more users,
wherein the one or more acoustic features comprise at least one of a waveform analysis, linear predictive cepstral coefficients (LPCC), mel frequency cepstrum coefficient (MFCC) and gammatone frequency cepstral coefficients (GFCC), mel-spectrogram, grapheme, a phoneme, and a tone.

10. The apparatus of claim 9, wherein wherein the instructions, when executed by the at least one processor individually and/or collectively, cause the apparatus to:
differentiate each user from the one or more users in the multi-user environment based at least on the extracted one or more acoustic features.

11. The apparatus of claim 8, wherein for the segmenting the converted respective text data into one or more segments, wherein the instructions, when executed by the at least one processor individually and/or collectively, cause the apparatus to:
convert each of characters in the text data into a high-dimensional vector representation;
analyze the high-dimensional vector representation respective of each of the characters;
determine a correlation between each of the characters based on the analysis of the high-dimensional vector representation respective of each of the characters;
determine a context and a pattern between each of the characters based on the correlation;
classify each of the characters in the text into one of a boundary or non-boundary based on the determined context and pattern, wherein the classified text with boundary indicates an end of one utterance among the one or more utterances and the classified text with non-boundary indicates a continuous utterance among the one or more utterances;
predict at least one of a location of a sentences and words having boundaries based on a result of the classification; and
segment, until the predicted location, the converted respective text data into the one or more segments based on a result of the prediction, wherein the one or more segments includes one or more sentences and one or more words.

12. The apparatus of claim 8, wherein for the translating each segment of the one or more segments into the output language, wherein the instructions, when executed by the at least one processor individually and/or collectively, cause the apparatus to:
select a language processing model from a plurality of language processing models for each of the one or more segments based at least on the recognized language corresponding to each of the one or more utterances in the respective segment; and
translate each of the one or more segments into the output language using the corresponding selected language processing model, wherein each of the one or more segments is translated in parallel with each other.

13. The apparatus of claim 9, wherein for generating the audio output, wherein the instructions, when executed by the at least one processor individually and/or collectively, cause the apparatus to:
fetch, from a database, a tone style embedding similar to the extracted one or more acoustic features corresponding to each of the one or more utterances respective of each user from the one or more user;
integrate the fetched tone style embeddings in each of the translated one or more segments; and
generate the audio output in the output language based on the integration of the fetched tone style embeddings in each of the translated one or more segments.

14. The apparatus of claim 8, wherein the output language is selected based at least one of:
an input from the one or more users in the multi-user environment; and
a specified selection criteria based on the recognized language using the audio input or a specified language.

15. A non-transitory computer-readable storage media storing computer-executable instructions that, when executed by at least one processor, comprising processing circuitry, of an apparatus, individually and/or collectively, causes the apparatus to perform at least one operation comprising:
receive an audio input including one or more utterances from one or more users in a multi-user environment;
convert each of the one or more utterances into a text data respective of the one or more utterances;
recognize a language corresponding to each of the one or more utterances based on the text data and acoustic features corresponding to each of the one or more utterances;
segment the text data corresponding to the one or more utterances into one or more segments based at least on the language corresponding to each of the one or more utterances;
translate each of the one or more segments into an output language; and
generate an audio output in the output language corresponding to the translated one or more segments.
